(19) United States
(12) Patent Application Publication
(10) Pub. No.: US 2026/0028469 A1
(43) Pub. Date: Jan. 29, 2026

(54) OPTICALLY RECOGNISABLE BIODEGRADABLE AND COMPOSTABLE COMPOSITION

(71) Applicants: Novamont S.p.A., Novara (IT); SAES GETTERS S.P.A., Lainate (MI) (IT)

(72) Inventors: Patrizio SALICE, Limbiate (MB) (IT); Paolo VACCA, Milano (IT); Agnello DE SIMONE, Saronno (VA) (IT); Stefano ZILIO, Bareggio (MI) (IT)

(73) Assignees: Novamont S.p.A., Novara (IT); SAES GETTERS S.P.A., Lainate (MI) (IT)

(21) Appl. No.: 18/998,850

(22) PCT Filed: Jul. 27, 2023
(86) PCT No.: PCT/EP2023/070881

§ 371 Date: Jan. 27, 2025

(30) Foreign Application Priority Data
Jul. 29, 2022 (IT) 102022000016230

(51) Int. Cl. C08K 5/1545; C08G 63/16

(52) U.S. Cl. CPC C08K 5/1545; C08G 63/16

(57) ABSTRACT

The present invention relates to a biodegradable compostable polymer composition comprising at least one diacid-diol polyester and at least one marker, and a method for tracking biodegradable compostable polymer compositions. Said marker comprises one or more photoactive elements incorporated into a microporous inorganic material via an ion exchange reaction.

### DESCRIPTION

The present invention relates to biodegradable compositions containing biopolymers and a photoactive marker through which they can be tracked, articles comprising them, and their preparation and transformation processes.

The term biopolymers generally refers to biodegradable and/or bio-based polymers. Biodegradable polymers are understood to be polymers that are capable of degrading and, once they have reached the end of their primary use, of being organically recycled through feeding microorganisms without generating an accumulation of waste in the environment. Compostable polymers are defined as polymers capable of disintegrating and biodegrading according to European standards EN14995 (plastics) and EN13432 (packaging). Bio-based polymers are defined as those obtained from natural or renewable resources, i.e. those obtained from sources that, by their very nature, can be regenerated within the time scale of a human life.

In view of the now widespread use of biopolymer compositions (so-called bioplastics) as an alternative to conventional plastics, a further increase in sustainability could be achieved by increasing the possibility of recovering and reusing the monomers from which they are made. This would in fact minimise the use of land and the production of renewable CO2, giving rise to a truly circular economy.

For this reason, new methods of recycling/re-use for bioplastics are also being developed alongside the recycling of conventional plastics.

However, while conventional plastics can be recycled in existing waste management and disposal plants, alternative and specific solutions based on the chemical and physical characteristics of these innovative materials are needed for biodegradable materials.

It is therefore essential that the recycling technologies used for bioplastics, which currently include mechanical recycling, chemical recycling and enzyme depolymerisation, are preceded by appropriate sorting operations applied to wastes from industry or consumers so that material streams with reduced variations in composition and purity, making them suitable for specific recycling treatments, can be selected.

It is known that plastics materials can be identified and separated by optical methods for this purpose.

Here, however, there often arises the problem that plastics also contain other foreign substances that can influence the optical properties of the plastics material, in addition to the polymer matrix. These foreign substances may, for example, be pigments, dyes or other additives added during industrial processing, or result from the use of the material, such as organic or inorganic residues. In addition to this, the materials may be discoloured or have become opaque as a result of ageing processes, due to e.g. light, heat or chemicals.

Consequently, even plastics of the same chemical class can differ in their colouring and it can happen that absorption or reflection measurements at defined wavelengths or wavelength bands produce different results. This makes it very difficult to obtain a uniform optical identification of these materials regardless of the foreign substances they contain, or the degree of soiling. use or age.

For these reasons, sorting methods based on targeted labelling or the incorporation of materials with luminescent substances, such as the one described in patent application US 2019/329297 A1, have been developed.

However, the particular conditions of preparing and processing biodegradable plastics involving high-temperature thermal processes can lead to deterioration of the characteristics of the luminescent organic substances incorporated into them. Thus a method for stabilising these substances without affecting the processability of the biodegradable plastics material during the stages of processing to the final product and without compromising its biodegradability must be found.

The applicants have now overcome this problem by incorporating an innovative marker system into biodegradable plastics materials by means of which they can be efficiently detected using existing optical detection technologies. Effective detection is ensured through the use of a marker whose photoactive element is protected by incorporating it into a microporous inorganic material. This marking system prevents oxidation and thermal degradation of the photoactive element as it is incorporated into the polymer composition, while maintaining its luminescence characteristics unchanged. In addition to being stable, said marker is also compatible with the main processes for preparing and processing polymer material and, thanks to its specific emission characteristics, is compatible with the optical properties of the polymer material itself, and can be detected even at low concentrations and in the presence of any additives.

It follows that biodegradable polymer compositions incorporating such a marker system are particularly suitable for use in tracking items that include them, for example in a waste sorting or end-of-life recovery process.

The object of the present invention is therefore a biodegradable and compostable polymer composition comprising at least one diacid-diol polyester (i), optionally one or more polyhydroxyalkanoates (ii), optionally one or more fillers (iii), and at least one marker comprising one or more photoactive elements incorporated into a microporous inorganic material (iv) via an ion exchange reaction.

Said biodegradable polymer composition can be easily prepared by means of a simple and inexpensive procedure that ensures that the biodegradable plastic material can be processed in the subsequent processing steps to obtain the final product.

The invention will be described in more detail below.

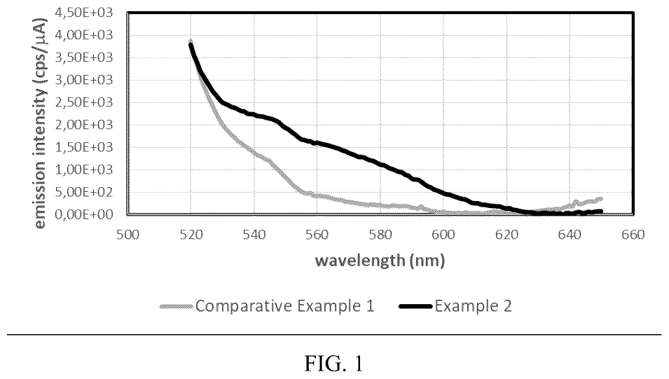

FIG. 1 shows the spectrum of the biodegradable and compostable polymer composition prepared in Comparative Example 1 and of the biodegradable and compostable polymer composition according to the invention prepared in Example 2, further comprising 0.085% w marker.

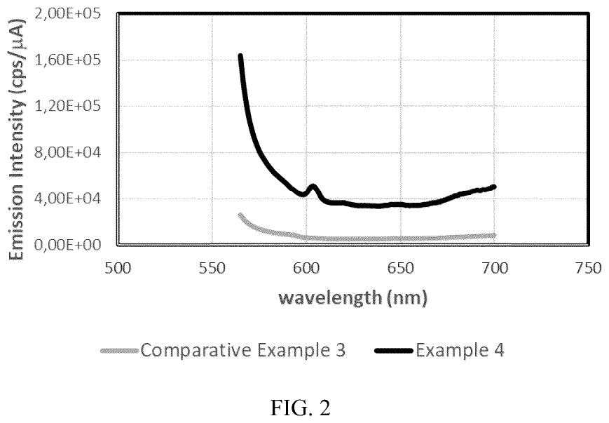

FIG. 2 shows the spectrum of the biodegradable and compostable polymer composition comprising prepared in Comparative Example 3 and of the biodegradable and compostable polymer composition according to the invention prepared in Example 4, further comprising 0.085% w marker.

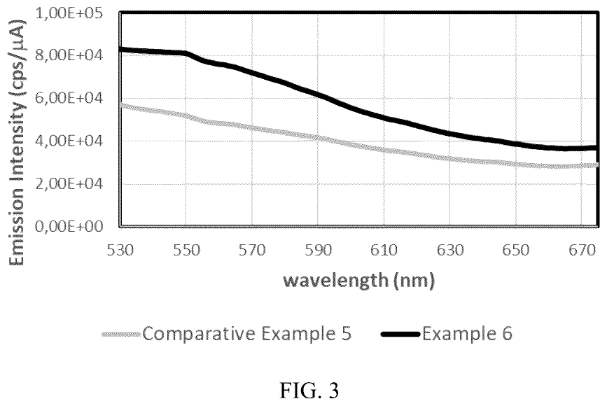

FIG. 3 shows the spectrum of the biodegradable and compostable polymer composition comprising a filler prepared in Comparative Example 5 and of the biodegradable and compostable polymer composition according to the invention prepared in Example 6, further comprising 0.051% w marker.

The biodegradable polymer composition according to the invention comprises at least one diacid-diol polyester (i). Said polyester is biodegradable according to EN 13432 and may be of either the aliphatic or aliphatic-aromatic type.

As far as the aliphatic-aromatic polyesters are concerned, they have an aromatic part consisting mainly of polyfunctional aromatic acids and an aliphatic part consisting of aliphatic diacids, aliphatic diols and mixtures thereof.

As for the aliphatic polyesters, they are obtained from aliphatic diacids, aliphatic diols and mixtures thereof.

Polyfunctional aromatic acids are understood to be dicarboxylic aromatic compounds of the phthalic acid type, preferably terephthalic acid or isophthalic acid, more preferably terephthalic acid, and heterocyclic dicarboxylic aromatic compounds, preferably 2,5-furandicarboxylic acid, 2,4-furandicarboxylic acid, 2,3-furandicarboxylic acid, 3,4-furandicarboxylic acid, their esters, salts and mixtures.

In a preferred embodiment, said aromatic dicarboxylic acids comprise:
from 1 to 99%, preferably 5 to 95% and more preferably from 10 to 80%, in moles of terephthalic acid, its esters or salts:
from 99 to 1%, preferably 95 to 5% and more preferably from 90 to 20%, in moles of 2.5-furandicarboxylic acid, its esters or salts.

Aliphatic diacids are C2 to C24, preferably C4-C13, more preferably C4-C11 aliphatic dicarboxylic acids, their C1-C24, more preferably C1-C4, alkyl esters, their salts and mixtures thereof. Preferably, the aliphatic dicarboxylic acids are selected from succinic acid, 2-methylsuccinic acid, 2-ethylsuccinic acid, glutaric acid, 2-methylglutaric acid, adipic acid, pimelic acid, suberic acid, azelaic acid, sebacic acid, undecandioic acid, dodecandioic acid, brassylic acid and their C1-C24 alkyl esters. Preferably said aliphatic dicarboxylic acids are selected from the group consisting of succinic acid, adipic acid, azelaic acid, sebacic acid, undecandioic acid, dodecandioic acid, brassylic acid and mixtures thereof.

The dicarboxylic component of the aliphatic or aliphatic-aromatic polyesters according to the present invention may comprise up to 5% of unsaturated aliphatic dicarboxylic acids, preferably selected from itaconic acid, fumaric acid, 4-methylene-pimelic acid, 3,4-bis (methylene) nonandioic acid, 5-methylene-nonandioic acid, their C1-C24, preferably C1-C4, alkyl esters, their salts and mixtures thereof. In a preferred embodiment of the present invention the unsaturated aliphatic dicarboxylic acids comprise mixtures comprising at least 50% in moles, preferably more than 60% in moles, more preferably more than 65% in moles of itaconic acid and/or its C1-C24, preferably C1-C4, esters. More preferably, the unsaturated aliphatic dicarboxylic acids comprise itaconic acid.

In the aliphatic or aliphatic-aromatic polyesters according to the present invention the diols are understood to be compounds having two hydroxyl groups, preferably selected from 1,2-ethanediol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,4-cyclohexanedimethanol, neopentylglycol, 2-methyl-1,3-propanediol, dianhydrosorbitol, dianhydromannitol, dianhydroiditol, cyclohexanediol, 1,4-bis(hydroxymethyl) cyclohexane, dialkylene glycols and polyalkylene glycols having molecular weights of 100-4000 such as polyethylene glycol, polypropylene glycol and mixtures thereof. Preferably, the diol component comprises at least 50% in moles of one or more diols chosen from 1,2-ethanediol, 1,3-propanediol, 1,4-butanediol. In a preferred embodiment of the present invention, the saturated aliphatic diol is 1,4-butanediol.

Advantageously, the diol may be obtained from renewable sources, from first or second generation sugars.

The diol component of the aliphatic or aliphatic-aromatic polyesters according to the present invention may comprise up to 5% of unsaturated aliphatic diols, preferably selected from cis 2-buten-1,4-diol, trans 2-buten-1,4-diol, 2-butyn-1,4-diol, cis 2-penten-1,5-diol, trans 2-penten-1,5-diol, 2-pentyn-1,5-diol, cis 2-hexen-1,6-diol, trans 2-hexen-1,6-diol, 2-hexen-1,6-diol, cis 3-hexen-1,6-diol, trans 3-hexen-1,6-diol, 3-hexen-1,6-diol.

The polyesters according to the present invention may also advantageously comprise repeating units derived from at least one hydroxy acid in an amount between 0) and 49%, preferably between 0) and 30%, in moles with respect to the total moles of the dicarboxylic component. Examples of convenient hydroxy acids are glycolic acid, glycolide, hydroxybutyric acid, hydroxycaproic acid, hydroxyvaleric acid. 7-hydroxyheptanoic acid. 8-hydroxycaproic acid. 9-hydroxynonanoic acid, lactic acid or lactide. The hydroxy acids may be inserted into the chain as such, or as prepolymers/oligomers, or they may also be previously reacted with diacids and/or diols.

According to a preferred embodiment of the invention, said diacid-diol polyester (i) is an aliphatic-aromatic polyester.

Said aliphatic-aromatic polyester (i) is preferably in an amount from 5 to 99.9% by weight relative to the total composition. According to one aspect of the invention it is present in an amount from 5 to 50%, preferably from 10 to 40%, by weight relative to the total composition. According to another aspect of the invention, it is present in an amount from 90 to 99.9% by weight with respect to the total weight of the composition and preferably represents the only polymer component therein.

The aliphatic-aromatic polyesters according to the present invention are characterised by an aromatic acid content of between 30 and 70% in moles, preferably between 40 and 60% in moles, in relation to the total dicarboxylic component.

In a preferred embodiment the aliphatic-aromatic polyesters are preferably selected from poly(1,4-butylene adipate-co-1,4-butylene terephthalate), poly(l.4-butylene sebacate-co-1,4-butylene terephthalate), poly (1.4-butylene azelate-co-1.4-butylene terephthalate), poly (l,4-butylene brassylate-co-1,4-butylene terephthalate), poly (l,4-butylene succinate-co-1,4-butylene terephthalate), poly(l,4-butylene adipate-co-1,4-butylene sebacate-co-1,4-butylene terephthalate), poly(l,4-butylene azelate-co-1,4-butylene sebacate-co-1,4-butylene terephthalate), poly(1,4-butylene adipate-co-1,4-butylene azelate-co-1,4-butylene sebacate-co-1,4-butylene succinate-co-1,4-butylene succinate-co-1,4-butylene adipate-co-1,4-butylene sucinate-co-1,4-butylene azelate-co-1,4-butylene terephthalate), poly(l,4-butylene terephthalate), poly(l,4-butylene terephthalate), poly l,4-butylene terephthalate) and mixtures thereof. In a particularly preferred embodiment the aliphatic-aromatic polyester is poly (1,4-butylene adipate-co-1.4-butylene terephthalate).

According to another preferred embodiment of the invention, said diacid-diol polyester (i) is an aliphatic polyester.

In the case of an aliphatic polyester, it preferably comprises a dicarboxylic component comprising. with respect to the total dicarboxylic component, 95-100% in moles of units derived from at least one saturated aliphatic dicarboxylic acid and 0-5% in moles of units derived from at least one unsaturated aliphatic dicarboxylic acid. It further comprises a diol component comprising, with respect to the total diol component, 95-100% in moles of units derived from at least one saturated aliphatic diol and 0-5% in moles of units derived from at least one unsaturated aliphatic diol.

In a particularly preferred embodiment, the aliphatic polyesters (i) according to the present invention are selected from the group consisting of poly (l,4-butylene succinate), poly (1,4-butylene succinate-co-adipate), poly (l,4-butylene succinate-co-1,4-butylene azelate) and mixtures thereof.

Said aliphatic polyester (i) is present in quantities of up to 80% by weight, preferably 20 to 60% by weight, of the total composition.

The aliphatic and/or aliphatic/aromatic polyesters in layer (i) according to the present invention may further advantageously comprise repeating units derived from at least one hydroxy acid, in an amount of between 0 and 49%, preferably between 0) and 30%, in moles relative to the total moles of the dicarboxylic component. Examples of convenient hydroxy acids are glycolic acid, hydroxy butyric acid, hydroxycaproic acid, hydroxyvaleric acid. 7-hydroxyheptanoic acid, 8-hydroxy caproic acid. 9-hydroxynonanoic acid, lactic acid or lactide. The hydroxy acids may be inserted into the chain as such or as prepolymers/oligomers, or they may also be pre-reacted with diacids or diols.

They may also be added in quantities of no more than 10 percent in moles to the total moles of the dicarboxylic component comprising long molecules with two functional groups, including non-terminal functional groups. Examples are dimer acids, ricinoleic acid and acids with epoxy groups, and also polyoxyethylenes with molecular weights between 200 and 10000.

Diamines, amino acids, and amino-alcohols may also be present in percentages of up to 30% in moles with respect to the total moles of the dicarboxylic component.

In the process of preparing aliphatic and/or aliphatic/aromatic polyesters (i) according to the present invention, one or more polyfunctional molecules may also be advantageously added, in amounts of between 0.1 and 3% in moles to the total moles of the dicarboxylic component, in order to obtain branched products. Examples of these molecules are glycerol, pentaery thritol, trimethylolpropane, citric acid, dipentaerythritol, monoanhydrosorbitol, monoanhydromannitol, acid triglycerides, polyglycerols, etc. The molecular weight Mn of said aliphatic and/or aliphatic-aromatic polyester (i) is preferably ≥20000, more preferably ≥40000. With regard to the polydispersity index of the molecular weights, Mw/Mn, this is preferably between 1.5 and 10, more preferably between 1.6 and 5 and even more preferably between 1.8 and 2.7.

The molecular weights Mn and Mw may be measured by Gel Permeation Chromatography (GPC). The determination may be made with the chromatographic system maintained at 40° C., using a set of two columns in series (particle diameter 5 um and 3 um with mixed porosity), a refractive index detector, chloroform as eluent (flow rate 0.5 ml/min) and using polystyrene as the reference standard.

The Melt Flow Rate (MFR) of the aliphatic and/or aliphatic-aromatic polyesters (i) is preferably between 500 and 1 g/10 min, more preferably between 100 and 3 g/10 min, even more preferably between 20 and 3 g/10 min (measurement carried out at 190° C./2.16 kg according to ISO 1133-1 “Plastics-determination of the melt mass-flow rate (MFR) and melt volume flow rate (MVR) of thermoplastics—Part 1: Standard method”).

The terminal acid groups content of said aliphatic and/or aliphatic-aromatic polyester (i) is preferably less than 100 meq/kg, preferably less than 60 meq/kg and even more preferably less than 40 meq/kg.

The terminal acid groups content may be measured as follows: 1.5-3 g of the polyester is placed in a 100 ml conical flask together with 60 ml of chloroform. After complete dissolution of the polyester, 25 ml of 2-propanol is added and, immediately before analysis, 1 ml of deionised water. The resulting solution is titrated with a previously standardised solution of NaOH in ethanol. An appropriate indicator, such as a glass electrode for acid-base titrations in non-aqueous solvents, is used to determine the equivalence point of the titration. The terminal acid groups content is calculated on the basis of the consumption of NaOH solution in ethanol according to the following equation:

$$Terminal acid groups content ( meq / kg polymer ) = \frac{[ ( Veq - Vb ) \cdot T ] \cdot 1000}{P}$$

$$where : Veq = ml of NaOH solution in ethanol at the equivalence point of the sample titration ;$$

$$Vb = ml of NaOH solution in ethanol required to achieve pH = 9.5 during the blank titration ;$$

$$T = concentration of NaOH solution in ethanol expressed in moles / litre ;$$

$$P = weight of sample in grams .$$

Preferably, said aliphatic and/or aliphatic/aromatic diacid-diol polyester (i) has an inherent viscosity (measured with a Ubbelohde viscometer for solutions in CHCl₃ in a concentration of 0.2 g/dl at 25° C.) greater than 0.3 dl/g. preferably between 0.3 and 2 dl/g. more preferably between 0.4 and 1.4 dl/g.

Said polyester (i) may be synthesised according to any of the processes known in the state of the art. In particular, it may be advantageously obtained by a polycondensation reaction. Advantageously, the process of synthesis may be conducted in the presence of a suitable catalyst. Examples of suitable catalysts include organometallic Tin compounds, e.g. stannic acid derivatives, Titanium compounds, e.g. ortho-butyltitanate, Aluminium compounds, e.g. Al-triisopropyl. Antimony and Zinc and Zirconium compounds and mixtures thereof.

Examples of processes of synthesis that can advantageously be used for the preparation of polyesters are described in international patent application WO 2016/050963.

The biodegradable and compostable polymer composition according to the present invention may further optionally comprise 0 to 5% by weight, more preferably 0.05 to 4% by weight. even more preferably 0.05 to 3% by weight of the total mixture, of at least one cross-linking agent and/or chain extender.

Said crosslinking agent and/or chain extender improves stability to hydrolysis and is selected from di-and/or poly-functional compounds bearing isocyanate, peroxide, carbodiimide, isocyanurate, oxazoline, epoxy, anhydride, divinyl ether groups and mixtures thereof. Preferably the crosslinking agent and/or chain extender comprises at least one di-and/or poly-functional compound bearing epoxide or carbodiimide groups.

Preferably, the crosslinking agent and/or chain extender comprises at least one di-and/or polyfunctional compound bearing isocyanate groups. More preferably, the crosslinking agent and/or chain extender comprises at least 25% by weight of one or more di-and/or polyfunctional compounds bearing isocyanate groups. Particularly preferred are mixtures of di- and/or polyfunctional compounds bearing isocyanate groups with di-and/or polyfunctional compounds bearing epoxide groups, even more preferably comprising at least 75% by weight of di-and/or polyfunctional compounds bearing isocyanate groups. Preferably, the di-and polyfunctional compounds bearing isocyanate groups are selected from p-phenylene diisocyanate, 2,4-toluene diisocyanate, 2,6-toluene diisocyanate, 4,4-diphenylmethanediisocyanate, 1,3-phenylene-4-chloro diisocyanate, 1,5-naphthalene diisocyanate, 4,4-diphenylene diisocyanate, 3,3′-dimethyl-4,4-diphenylmethane diisocyanate, 3-methyl-4,4′-diphenylmethane diisocyanate, diphenyl ether diisocyanate. 2.4-cyclohexane diisocyanate, 2,3-cyclohexane diisocyanate, 1-methyl 2.4-cyclohexyl diisocyanate, 1-methyl 2.6-cyclohexyl diisocyanate, bis(isocyanate cyclohexyl) methane, 2.4,6-toluene triisocyanate, 2,4,4-diphenylether triisocyanate, polymethylene-polyphenyl-polyisocyanates, methylene diphenyl diisocyanate, triphenylmethane triisocyanate, 3,3′-ditolylene-4,4-diisocyanate, 4,4′-methylenebis(2-methyl-phenyl isocyanate), hexamethylene diisocyanate, 1,3-cyclohexylene diisocyanate, 1,2-cyclohexylene diisocyanate and mixtures thereof. In a preferred embodiment, the compound bearing isocyanate groups is 4,4-diphenylmethane-diisocyanate.

With regard to the di- and polyfunctional compounds bearing peroxide groups, these are preferably selected from benzoyl peroxide, lauroyl peroxide, isononanoyl peroxide, di-(t-butylperoxy)disopropyl)benzene, t-butyl peroxide, dicumyl peroxide, alpha, alpha′-di(t-butylperoxy)diisopropylbenzene, 2,5-dimethyl-2,5-di(t-butylperoxy) hexane, t-butyl cumyl peroxide, di-t-butyl peroxide, 2,5-dimethyl-2.5-di(t-butylperoxy)-hex-3-yne, di (4-t-butylcyclohexyl) peroxy dicarbonate, dicetyl peroxy dicarbonate, dimyristyl peroxy dicarbonate, 3,6,9-triethyl-3,6,9-trimethyl-1,4,7-triperoxonane, di(2-ethy lhexyl) peroxydicarbonate and mixtures thereof. The di-and poly-functional compounds bearing carbodiimide groups which are preferably used in the mixture according to the present invention are chosen from poly(cyclooctylene carbodiimide), poly(1,4-dimethylcyclohexylene carbodiimide), poly(cyclohexylene carbodiimide), poly(ethylene carbodiimide), poly(butylene carbodiimide), poly(isobutylene carbodiimide), poly(nonylene carbodiimide), poly(dodecylene carbodiimide), poly(neopentylene carbodiimide), poly(l,4-dimethylene phenylene carbodiimide), poly(2,2′,6,6′-tetraisopropyldiphenylene carbodiimide) (Stabaxol®; D), poly(2,4,6-triisopropyl-1,3-phenylene carbodiimide) (Stabaxol® P-100), poly (2,6-diisopropyl-1,3-phenylene carbodiimide) (Stabaxol® P), poly(tolyl carbodiimide), poly (4,4′-diphenylmethane carbodiimide), poly(3,3′-dimethyl-4,4′-biphenylene carbodiimide), poly(p-phenylene carbodiimide), poly(m-phenylene carbodiimide), poly(3,3′-dimethyl-4,4′-diphenylmethane carbodiimide), poly(naphthylene carbodiimide), poly(isophorone carbodiimide), poly(cumene carbodiimide), p-phenylene bis(ethylcarbodiimide), 1,6-hexamethylene bis(ethylcarbodiimide), 1,8-octamethylene bis(ethylcarbodiimide), 1,10-decamethylene bis(ethylcarbodiimide), 1,12-dodecamethylene bis(ethylcarbodiimide) and mixtures thereof.

Examples of the di- and polyfunctional compounds bearing epoxy groups which may advantageously be used in the mixture according to the present invention are all polyepoxides from epoxidised oils and/or styrene-glycidyl ether-methyl methacrylate, glycidyl ether-methacry late, included in a molecular weight range between 1000 and 10000 and with a number of epoxides per molecule in the range from 1 to 30, and preferably between 5 and 25, and epoxides selected from the group comprising: diethylene glycol diglycidyl ether, polyethylene glycol diglycidyl ether, polyglycerol polyglycidyl ether, 1,2-epoxy butane, polyglycerol polyglycidyl ether, diepoxide, isoprene and cycloaliphatic diepoxides, 1,4-cyclohexanedimethanol diglycidyl ether, glycidyl 2-methylphenyl ether, glycerol propoxylatotriglycidyl ether, 1,4-butanediol diglycidyl ether, sorbitol polyglycidyl ether, glycerol diglycidyl ether, tetraglycidyl ether of meta-xylenediamine and diglycidyl ether of bisphenol A and mixtures thereof.

In a particularly preferred embodiment of the invention, the crosslinking agent and/or chain extender comprises compounds bearing isocyanate groups preferably 4,4-diphenylmethane diisocyanate, and/or bearing carbodiimide groups, and/or bearing epoxide groups, preferably of the styrene-glycidyl-ether-methylmethacrylate type. In a particularly preferred embodiment of the invention the crosslinking agent and/or chain extender comprises compounds bearing epoxy groups of the styrene glycidylether-methylmethacrylate type. Along with the di- and polyfunctional compounds bearing isocyanate, peroxide, carbodiimide, isocyanurate, oxazoline, epoxy, anhydride or divinyl ether groups, catalysts may also be used to make the reactivity of the reactive groups higher. In the case of polyepoxides. fatty acid salts are preferably used, even more preferably calcium and zinc stearates.

The composition according to the invention optionally comprises a polyhydroxyalkanoate (ii). preferably in an amount higher than or equal to 1% by weight. more preferably higher than 5% by weight, relative to the total composition. It is advantageously present in an amount from 20to 80% by weight, more preferably from 40 to 75% by weight, even more preferably from 55to 70% by weight, relative to the total composition. Said polyhydroxyalkanoates (ii) are preferably selected from the group consisting of lactic acid polyesters, poly-ε-caprolactone, polyhydroxy butyrate, polyhydroxy butyrate-valerate, polyhydroxybutyrate propanoate, polyhydroxy butyrate-hexanoate, polyhydroxy butyrate-decanoate, polyhydroxy butyrate-dodecanoate, polyhydroxy butyrate-hexadecanoate, polyhydroxy butyrate-octadecanoate. poly-3-hydroxy butyrate-4-hydroxy butyrate and mixtures thereof. Preferably the polyhydroxyalkanoate (ii) of the composition comprises at least 70% by weight, more preferably at least 80% by weight, of one or more lactic acid polyesters. In a preferred embodiment the lactic acid polyesters are selected from the group consisting of poly L-lactic acid, poly D-lactic acid, poly D-L lactic acid stereo complex, copolymers comprising more than 50% by weight of said lactic acid polyesters or mixtures thereof. Particularly preferred are lactic acid polyesters containing at least 95% by weight of repeating units derived from L-lactic or D-lactic acid or mixtures thereof having a molecular weight Mw greater than 50000 and having a shear viscosity between 50 and 700 Pa·s preferably between 80 and 500 Pa·s (measured according to ASTM D3835 standard at T=190° C., shear rate=1000s-1, D=1 mm, L/D=10). In a particularly preferred embodiment of the present invention the lactic acid polyester comprises at least 95% by weight of units derived from L-lactic acid, ≤5% by weight of repetitive units derived from D-lactic acid, has a melting point in the range 135-175° C., a Glass Transition Temperature (Tg) in the range 55-65° C. and a MFR (measured according to ASTM-D1238 standard at 190° C. and 2.16 kg) in the range 1-50 g/10 min. Commercial examples of lactic acid polyesters with these properties include the Ingeo™ Biopolymer brand products 4043D, 3251D, 6202D, and the Luminy R: brand product L105.

In a preferred embodiment of the present invention the composition comprises 5-50% by weight, preferably 10-45% and even more preferably 15-40% by weight, relative to the sum of components (i) and (ii), of at least one diacid-diol polyester (i) of the aliphatic-aromatic type, and 50-95% by weight, preferably 55-80% and even more preferably 58-75% by weight. relative to the sum of components (i) and (ii), of a lactic acid polyester (ii).

In the composition according to the invention diacid-diol polyester (i) may also be mixed with other polymers of synthetic or natural origin, whether biodegradable or not.

With regard to biodegradable and non-biodegradable polymers of synthetic or natural origin, these are advantageously selected from the group consisting of vinyl polymers, diacid diol polyesters other than or the same as the aliphatic and/or aliphatic-aromatic polyesters described above, polyamides, polyurethanes, polyureas, polycarbonates and mixtures thereof. In a particularly preferred form, said polymers may be blended with the biodegradable polyester according to the invention in amounts up to 80% by weight.

Preferred vinyl polymers include polyethylene, polypropylene, their copolymers, polyvinyl alcohol, polyethylene vinyl acetate and polyethylene vinyl alcohol, polystyrene, chlorinated vinyl polymers, polyacrylates. The chlorinated vinyl polymers here are considered to include, in addition to polyvinyl chloride, polyvinylidene chloride, poly(vinylchloride-vinylacetate), poly(vinylchloride-ethylene), poly(vinylchloride-propylene), poly(vinylchloride-styrene), poly(vinylchloride-isobutylene) as well as copolymers in which polyvinyl chloride accounts for more than 50% in moles. Such copolymers may be random, block or alternating.

As far as the polyamides are concerned, these are preferably selected from the group consisting of polyamide 6 and 66, polyamide 9 and 9.9, polyamide 10 and 10.10, polyamide 11 and 11.11, polyamide 12 and 12.12 and their combinations of the types 6/9, 6/10, 6/11, 6/12 and their blends and copolymers, both random and block.

Preferably, the polycarbonates of the composition according to the present invention are selected from the group consisting of polyalkylene carbonates, more preferably polyethylene carbonates, polypropylene carbonates, polybutylene carbonates, their blends and both random and block copolymers.

Of the polyethers, those preferred are selected from the group consisting of polyethylene glycols, polypropylene glycols, poly butylene glycols, their copolymers and their blends having molecular weights from 70000 to 500000.

As for the diacid-diol polyesters, these preferably include:
a) a dicarboxylic component comprising, compared to the total dicarboxylic component:
   (a1) 20-100% in moles of units derived from at least one aromatic dicarboxylic acid,
   (a2) 0-80% in moles of units derived from at least one saturated aliphatic dicarboxylic acid,
   (a3) 0-5% in moles of units derived from at least one unsaturated aliphatic dicarboxylic acid:
b) a diol component comprising, compared to the total diol component:
   (b1) 95-100% in moles of units derived from at least one saturated aliphatic diol:
   (b2) 0-5% in moles of units derived from at least one unsaturated aliphatic diol.

Preferably, aromatic aliphatic dicarboxylic acids a1, saturated aliphatic dicarboxylic acids a2, unsaturated aliphatic dicarboxylic acids a3, saturated aliphatic diols b1 and unsaturated aliphatic diols b2 for said polyesters are selected from those described above for diacid-diol polyester (i) according to the present invention.

As for polymers of natural origin, these are advantageously selected from starch, chitin, chitosan, alginates, proteins such as gluten, zein, casein, collagen, gelatin, natural gums, cellulose (also in nanofibrils) and pectin. Any polymers of natural origin are preferably present up to 40% by weight, more preferably up to 30% by weight with respect to the total weight of the composition.

Preferred examples are cellulose fibres, present in quantities of 1 to 25% by weight, more preferably 4 to 15% by weight. They preferably have a length-to-diameter (L/D) ratio <40, preferably L/D<30 and even more preferably L/D<20, do not cause excessive increases in the elastic modulus or significant decreases in the tensile stress of the polymer composition at break, or an appreciable reduction in its ability to flow in the molten state.

Another preferred example of a polymer of natural origin that may be present in the composition of the invention is starch.

The term starch is understood here to mean all types of starch, i.e. flour, native starch, hydrolysed starch, destructured starch, gelatinised starch, plasticised starch, thermoplastic starch, biofillers comprising complexed starch or mixtures thereof. Particularly suitable according to the invention are starches such as potato, maize, tapioca and pea starch. Particularly advantageous are starches capable of being easily destructured and having high initial molecular weights, such as potato or maize starch. Starch can be present both as such and in a chemically modified form, such as in the form of starch esters with a degree of substitution between 0.2 and 2.5, hydroxypropyl starch, and starch modified with fat chains. By destructured starch, reference is made herein to the teachings contained in Patents EP-0 118240 and EP-0 327 505, starch processed in such a way that it does not substantially show the so-called “Maltese crosses” under the optical microscope in polarised light and the so-called “ghosts” under the optical microscope in phase contrast. Advantageously, destructuring of starch is carried out by an extrusion process at temperatures between 110-250° C., preferably 130-180° C., pressures between 0.1-7 MPa, preferably 0.3-6 MPa, preferably providing a specific energy of more than 0.1 kWh/kg during said extrusion. The destructuring of the starch preferably takes place in the presence of 1-40% by weight relative to the weight of the starch of one or more plasticisers chosen from water and polyols having 2 to 22 carbon atoms. As far as water is concerned, this may also be the water naturally present in starch. Of the polyols, polyols with 1 to 20 hydroxyl groups containing 2 to 6 carbon atoms, their ethers, thioethers and organic and inorganic esters are preferred. Examples of said polyols are glycerol, diglycerol, polyglycerol, pentaerythritol, ethoxylated polyglycerol, ethylene glycol, polyethylene glycol, 1,2-propanediol, 1,3-propanediol, 1.4-butanediol, neopentylglycol, sorbitol, sorbitol monoacetate, sorbitol diacetate, sorbitol monoethoxylate, sorbitol diethoxylate, and mixtures thereof. In a preferred embodiment the starch is destructured in the presence of glycerol or a mixture of plasticisers comprising glycerol, more preferably comprising between 2 and 90% by weight glycerol. Preferably, the destructured and cross-linked starch according to the present invention comprises between 1-40% by weight relative to the weight of the starch of plasticisers. When present, the starch in the composition according to the present invention is preferably in the form of particles having a circular, elliptical or otherwise ellipse-like cross-section having an arithmetic mean diameter, measured taking the major axis of the particle into account, of less than 1 micron and more preferably less than 0.5 μm.

Compositions according to the invention comprising starch are particularly suitable for use in film forming, for obtaining single-layer or multi-layer films.

The composition according to the invention further optionally comprises one or more fillers or filling agents (iii), in an amount from 0 to 50% by weight with respect to the total weight of the composition or, according to a preferred aspect, from 1 to 40% by weight. Said filler has an average particle diameter of more than 700 nm, preferably >800 nm and more preferably >1 μm. Advantageously, for some applications, the particle size of the filler measured by dynamic light scattering is characterised by a distribution in which D95 is equal to or less than 10 micrometres.

Examples of particularly preferred fillers are talc, clays, silica, mica, kaolin, titanium dioxide, calcium carbonate, wollastonite and mixtures thereof. Talc and calcium carbonate are preferred. Components (i) to (iii) of the polymer composition according to the invention and/or mixtures thereof are characterised by a transmittance more than 50%, preferably more than 60%, even more preferably more than 70% in the range from 900 nm to 1650 nm.

According to a preferred aspect, component (i) is characterised by a transmittance of more than 60%, preferably more than 70% in the range from 600 nm to 800 nm. In such a case, component (i) is preferably an aliphatic-aromatic polyester.

With regard to the photoactive element of said marker iv), it is organic in nature and characterised by being fluorescent. Photoactive elements characterised by radiation emission in the range 550-650 nm are particularly suitable for use in marker iv) according to the invention. They advantageously belong to the rhodamine family and their derivatives with fluorophore groups. Such fluorescent dyes can be detected easily and inexpensively using techniques known in the art, such as spectrofluorimetry; e.g. using a fluorometer.

One example of a photoactive element is rhodamine B. The photoactive element is incorporated into a microporous inorganic material through an ion exchange reaction. This inorganic material has pores ranging in size from 4 Å to 12 Å and is a zeolite. A dye exchanged zeolite marker is therefore obtained. An example of possible preparation method of said dye exchanged zeolite marker can be found in the IT patent application Ser. No. 10202,2000016188.

Said marker (iv) is present in the biodegradable and compostable composition according to the invention in amounts preferably equal to or greater than 0.01% by weight, more preferably equal to or greater than 0.025% by weight and even more preferably equal to or greater than 0.05% by weight with respect to the weight of the composition. For example, amounts greater than or equal to 0.1% by weight are advantageously used. The marker (iv) is advantageously present in amounts less than or equal to 0.5% by weight, preferably less than or equal to 0.3% by weight, for example from 0.1% to 0.2% by weight, with respect to the total weight of the composition.

The biodegradable polymer composition according to the invention may further optionally comprise one or more additives selected from the group consisting of plasticisers, UV stabilisers, lubricants, nucleating agents, surfactants, antistatic agents, pigments, compatibilising agents, lignin, organic acids, antioxidants, anti-mould agents, waxes and process aids and polymer components preferably selected from the group consisting of vinyl polymers and diacid diol polyesters other than or the same as the aliphatic and/or aliphatic- aromatic polyesters described above. Each additive is preferably present in an amount of less than 10% by weight, more preferably less than 5% by weight, even more preferably less than 1% by weight of the total weight of the mixture.

As far as the plasticisers are concerned, in addition to the plasticisers preferably used for the preparation of destructured starch described above, these are selected from the group consisting of trimellitates, such as trimellitic acid esters with C4-C20 mono-alcohols preferably selected from the group consisting of n-octanol and n-decanol, and aliphatic esters having the following structure:

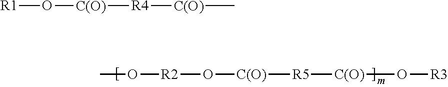

in which: R1 is selected from one or more of the groups formed by H, linear and branched saturated and unsaturated alkyl residues of the C1-C24 type, residues of polyols esterified with C1-C24 monocarboxylic acids: R2 comprises-CH2-C(CH3)2-CH2-and C2-C8 alkylene groups, and comprises at least 50% in moles of said-CH2-C (CH3) 2-CH2-groups; R3 is selected from among one or more of the groups formed by H, linear and branched saturated and unsaturated alkyl residues of the C1-C24 type, polyol residues esterified with C1-C24 monocarboxylic acids: R4 and R5 are the same or different, comprise one or more C2-C22, preferably C2-C11, more preferably C4-C9 alkenes, and comprise at least 50% in moles of C7 alkenes; m is a number between 1-20, preferably 2-10, more preferably 3-7. Preferably, in said esters at least one of groups R1 and/or R3 comprises, preferably in an amount of ≥10% in moles, more preferably ≥20%, even more preferably >25% in moles with respect to the total amount of groups R1 and/or R3, polyol residues esterified with at least one C1-C24 monocarboxylic acid selected from the group consisting of stearic acid, palmitic acid, 9-ketostearic acid, 10-ketostearic acid and mixtures thereof. Examples of such aliphatic esters are described in Italian patent application MI2014A000030 and international patent applications WO 2015/104375 and WO 2015/104377.

The lubricants are preferably selected from esters and metal salts of fatty acids such as, for example, zinc stearate, calcium stearate, aluminium stearate and acetyl stearate. Preferably, the composition according to the present invention comprises up to 1% by weight of lubricants, more preferably up to 0.5% by weight, relative to the total weight of the composition. Examples of nucleating agents include saccharin sodium salt, calcium silicate, sodium benzoate, calcium titanate, boron nitride, isotactic polypropylene, low molecular weight PLA. Pigments may also be added if required, e.g. clays, azo pigments (such as the red pigment ‘basic red 18’ and the yellow pigment ‘Corimax Yellow H10G’), hydrazone pigments, polycyclic organic pigments (such as the blue pigment ‘Pigment Blue 62’), titanium dioxide, silicates, iron oxides and hydroxides, carbon black, and magnesium oxide. In the case of inorganic pigments, they have an average particle diameter advantageously greater than 700 nm, preferably >800 nm and more preferably >1 μm.

Process aids such as sliding and/or releasing agents include, for example, biodegradable fatty acid amides such as oleamide, erucamide, ethylene-bis-stearylamide, fatty acid esters such as glycerol oleates or glycerol stearates, or saponified fatty acids such as stearates. Process aids are preferably present in quantities of less than 10% by weight, more preferably less than 5% by weight, even more preferably less than 1% by weight of the total weight of the mixture.

Advantageously, the polymer composition according to the present invention is produced by extrusion processes in which the components are mixed in a molten state. In extruding the composition, the components can be fed all together or one or more of them can be fed separately along the extruder.

Since the microporous inorganic marker material (iv) typically has a high tendency to adsorb water, incorporation into the composition according to the invention is advantageously preceded by a dehydration or drying treatment. For example, it is preferable that the marker should be dried (e.g. for times of more than one hour in a vacuum oven at a temperature of 90° C.) so as to reduce the amount of water it contains to below 1000 ppm and to process it quickly or under a flow of nitrogen to avoid the absorption of atmospheric moisture. This avoids introducing excessive amounts of water into the extrusion process, which would lead to instability and inhomogeneity in the extrusion process.

The processability and uniform distribution of small amounts of marker in the final product is also improved by dispersing the marker (iv) in a masterbatch.

For example, said marker, preferably dried, is physically mixed with the further components of the biodegradable polymer composition to obtain a physical mixture (dry blend) which can be further dried to remove any residual moisture. The physical blend of the dried marker and the components of the biodegradable and compostable polymer composition can subsequently be metered into an extruder.

The marking system according to the present invention has the additional advantage of limiting the migration of photoactive elements into the final product, with benefits in applications where this would be a problem (e.g. contact with foodstuffs).

A further aspect of the invention therefore concerns the process of preparing a biodegradable polymer composition comprising the steps of:
a) subjecting a marker comprising a photoactive element supported on a microporous inorganic material to drying until a water content of less than 2000 ppm, preferably <1500 ppm, more preferably <1000 ppm, is obtained:
(b) incorporating said marker (dispersed phase) into one or more of the components (i)-(iii) of the biodegradable polymer composition (dispersant phase) by extrusion, preferably at a peak temperature of 120° to 220° C., preferably 130° to 180° C.

According to a preferred aspect of the invention, the marker is preferably mixed with a polymer dispersant phase in an amount of 10 to 60% by weight, preferably 15 to 30% by weight, with respect to said dispersant phase. The polymer composition thus obtained is used as a masterbatch for the preparation of a further polymer composition according to the invention, at a masterbatch concentration preferably from 0.1 to 5% by weight, more preferably from 0.3% to 3% by weight, even more preferably from 0.5 to 2.5% by weight of the total final composition.

Accordingly, in step b) of the process, said marker is dispersed in an amount of 10 to 60% by weight, preferably 15 to 30% by weight, relative to the dispersion step: said process comprises a further step c) in which the composition obtained in step b) is used as a masterbatch in a further polymer composition, at a concentration of 0.1 to 5% by weight, preferably 0.5 to 2.5% by weight relative to the weight of the final composition.

The polymer compositions obtained from said masterbatch may be obtained by techniques known to those skilled in the art, e.g. by extrusion or as a dry blend.

In the preparation of polymer compositions, the masterbatch is advantageously used in the absence of moisture, e.g. by drying or under a flow of inert gas, as described above.

The polymer composition according to the present invention is particularly suitable for use in injection moulding and thermoforming, as well as in spinning and film forming according to methods known to those skilled in the art. The articles obtained may also be subjected to hot annealing at temperatures between 60 and 150° C.

For example, the polymer composition according to the invention is particularly suitable for the manufacture of disposable cutlery, plates and cups, rigid containers, beverage dispensing capsules, preferably hot beverages, caps and lids, packaging for food that can be heated in conventional and microwave ovens, expanded articles, preferably expanded articles obtained by extrusion or injection moulding, fibres, films or sheets consisting of one or more layers comprising the composition according to the present invention.

Biodegradable and compostable articles comprising the composition described above, such as the articles listed above, are therefore also an object of the invention.

The polymer composition according to the present invention is preferably biodegradable and compostable according to UNI EN 13432. According to one aspect of the invention, the articles obtained from said composition are rapidly biodegradable under industrial composting conditions and more preferably in home composting according to standard UNI 11355.

The invention further relates to a method for tracking biodegradable polymer compositions comprising the steps of preparing the articles described above and subjecting said articles to detection of the photoactive element using a spectrofluorimeter. preferably one having two monochromators with continuously adjustable slits for adjusting the spectral resolution and intensity of the fluorescence signal. For this purpose. a spectrofluorimeter with a source consisting of an ozone-free xenon arc lamp (Po=150 W) with a continuous light source in the 200-800 nm range focused on the input slit of the excitation monochromator may for example be used. The use of an instrument based on two Czerny-Turner type monochromators allows the incident light to be scattered by means of a reflection grating. Optical spectra can be obtained by rotating the gratings and recording the intensity values at each wavelength. The input and output ports of each monochromator include continuously adjustable slits to control the spectral resolution and intensity of the fluorescence signal recorded by a photomultiplier tube. The solid sample holder mounted on an adjustable goniometer can be used to test polymer products in the form of 1 to 3 mm thick films admixed with the photoactive element. A sample configuration with a 60° angle between the incident and specularly reflected beam prevents the excitation beam from entering the emission slit. thus avoiding interference with the light scattered by the sample under test.

More generally, the items described above can be detected by using optical sorting machines equipped with suitable systems for light excitation in the range 500-600 nm (broad-spectrum lamps. laser diodes) and VIS (wavelengths in the visible range) and NIR (near-infrared wavelengths) spectrometric sensors for the detection of photoemitted radiation (>570 nm).

The composition and preparation process according to the present invention are illustrated without limitation in the following examples.

### EXAMPLES

### Comparative Example 1

Poly (l,4-butylene adipate-co-1,4-butylene terephthalate) (PBAT) having 47% moles of aromatic units with respect to the dicarboxylic component and an MFR of 97 g/10 min (measured at 190° C. with a weight of 2.16 kg and melt density of 1.05 g/cm³ according to standard ISO 1133-1) has been converted through an injection moulding process obtaining sheets with dimensions 70×80×1 mm under the following conditions
injection temperature: 180° C.
injection pressure: 750 bar

The sheets obtained have been subjected to detection of the photoactive element using a spectrofluorometer according to the method described below in Example 2. The spectrum has been compared to the spectrum of the sample sheets of Example 2, as reported in FIG. 1.

### Example 2

A biodegradable and compostable polymer composition according to the invention comprising a diacid-diol polyester (i) and a marker (iv) was prepared as follows.

The marker (iv) comprising Rhodamine B incorporated into a zeolite with a pore size of 4 Å to 12 Å was dried in a vacuum oven at 150° C. for 2 hours until a water content of approximately 320 ppm was obtained. 85 g of said marker was physically mixed with 415 g of poly (l,4-butylene adipate-co-1,4-butylene terephthalate) (PBAT) having 47% moles of aromatic units with respect to the dicarboxylic component and an MFR of 97 g/10 min (measured at 190° C. with a weight of 2.16 kg and melt density of 1.05 g/cm³ according to standard ISO 1133-1), further dried at 90° C. for 2 hours, and fed to a Haake counter-rotating twin-screw extruder (barrel: 22×125 mm, 1-hole circular die with a diameter of 3 mm) forming part of a spaghetti extrusion line with water bath, dryer and cutter, operating under the following conditions
rpm: 100
flow rate: 35 rpm
thermal profile: 80-140-130-100° C.

The resulting composition consisted of 83% by weight PBAT and 17% by weight marker. 0.5 PHR of the resulting composition has then been physically mixed with the biodegradable and compostable polyester PBAT used in Comparative Example 1.

The mixture of granules has been converted through an injection moulding process obtaining sheets with dimensions 70×80×1 mm under the following conditions
injection temperature: 180° C.
injection pressure: 750 bar

The marker is present in an amount of 0.085% by weight in the polymer composition. The sheets obtained have been subjected to detection of the photoactive element using a spectrofluorometer, as described below. The spectra reported in FIG. 1 are an average of several spectra for each sample sheet of Comparative Example 1 and Example 2. Mean values at emission (575 nm) are respectively 231 cps/μA (Comparative Example 1) and 1276 cps/μA (Example 2).

Experimental: the excitation wavelength was set at 500 nm, i.e. lower than the maximum value of the excitation peak to avoid overlapping between the excitation and emission signals. The aperture of the front input and output slits were calibrated to boost the signal in order to obtain a clearly detectable signal within the linearity range of the PMT detector. The 5 nm bandwidth was kept at the same value for both Comparative Example 1 and Example 2 in order to have comparable scales. Dark offset was enabled. The corrected signal SIC on the PMT and the corrected reference signal R1C of the lamp were included in the acquisition panel to obtain S1C/R1C taking into account corrections for PMT sensitivity and intensity variations of the Xe-lamp source respectively. A 1 s accumulation time was set to obtain an averaged signal.

### Comparative Example 3

A biodegradable and compostable polymer composition, consisting of 79% PBTA having 47% moles of aromatic units with respect to the dicarboxylic component, 20% polylactic acid (PLA) Ingeo 4043D, 1% additives and having a MFR 3.8 g/10 min (measured at 190° C. with a weight of 2.16 kg and melt density of 1.11 g/cm³ according to standard ISO 1133-1) has been converted through a film blowing process obtaining a film with a thickness of 20±5 micrometers under the following conditions
thermal profile: 140-185-160×2-155° C.

The film obtained has been subjected to spectrofluorimetric analysis according to the method described below in Example 4. The spectrum has been compared to the spectrum of the sample film of Example 4, as reported in FIG. 2.

### Example 4

A biodegradable and compostable polymer composition according to the invention comprising a diacid-diol polyester (i) and a marker (iv) was prepared as follows.

The marker (iv) comprising Rhodamine B incorporated into a zeolite with a pore size of 4 Å to 12 Å was dried in a vacuum oven at 150° C. for 2 hours until a water content of approximately 320 ppm was obtained. 85 g of said marker was physically mixed with 415 g of poly (1,4-butylene adipate-co-1,4-butylene terephthalate) (PBAT) having 47% moles of aromatic units with respect to the dicarboxylic component and an MFR of 97 g/10 min (measured at 190° C. with a weight of 2.16 kg and melt density of 1.05 g/cm³ according to standard ISO 1133-1), further dried at 90° C. for 2 hours, and fed to a Haake counter-rotating twin-screw extruder (barrel: 22×125 mm, 1-hole circular die with a diameter of 3 mm) forming part of a spaghetti extrusion line with water bath, dryer and cutter, operating under the following conditions
rpm: 100
flow rate: 35 rpm
thermal profile: 80-140-130-100° C.

The resulting composition consisted of 83% by weight PBAT and 17% by weight marker. 0.5 PHR of the resulting composition has then been physically mixed with the biodegradable and compostable polyester composition used in Comparative Example 3 comprising 79% PBTA and 20% PLA.

The mixture of granules has been converted through a film blowing process obtaining a film with a thickness of 20±5 micrometers under the following conditions
thermal profile: 140-185-160×2-155° C.

The marker is present in an amount of 0.085% by weight in the polymer composition. The film obtained has been subjected to detection of the photoactive element using a spectrofluorometer, as described below. The spectra reported in FIG. 2 are an average of several spectra for each sample of Comparative Example 3 and Example 4. Mean values at emission (580 nm) are respectively 10842 cps/μA (Comparative Example 3) and 66237 cps/μA (Example 4).

Experimental: the excitation wavelength was set at 550 nm, i.e. lower than the maximum value of the excitation peak to avoid overlapping between the excitation and emission signals. The aperture of the front input and output slits were calibrated to boost the signal in order to obtain a clearly detectable signal within the linearity range of the PMT detector. The 4 nm bandwidth was kept at the same value for both Comparative Example 3 and Example 4 in order to have comparable scales. Dark offset was enabled. The corrected signal S1C on the PMT and the corrected reference signal R1C of the lamp were included in the acquisition panel to obtain S1C/R1C taking into account corrections for PMT sensitivity and intensity variations of the Xe-lamp source respectively. A 1 s accumulation time was set to obtain an averaged signal.

### Comparative Example 5

A biodegradable and compostable polymer composition comprising 43.9% of poly butylene succinate (PBS), 21.2% polylactic acid (PLA) Ingeo 4043D, 0.07% Carbodilite HMV-5CA-LC, 0.3% Crodammide ER Beads, 34.53% Talc Ecofill (average particle diameter of 7800 nm) from Imi Fabi, has been converted through an injection moulding process obtaining sheets with dimensions 70×80×1 mm under the following conditions
injection temperature: 220° C.
injection pressure: 750 bar

The sheets obtained have been subjected to detection of the photoactive element using a spectrofluorometer according to the method described below in Example 6. The spectrum has been compared to the spectrum of the sample sheets of Example 6, as reported in FIG. 3.

### Example 6

A biodegradable and compostable polymer composition according to the invention comprising a diacid-diol polyester (i) and a marker (iv) was prepared as follows.

The marker (iv) comprising Rhodamine B incorporated into a zeolite with a pore size of 4 Å to 12 Å was dried in a vacuum oven at 150° C. for 2 hours until a water content of approximately 320 ppm was obtained. 85 g of said marker was physically mixed with 415 g of poly (1,4-butylene adipate-co-1,4-butylene terephthalate) (PBAT) having 47% moles of aromatic units with respect to the dicarboxylic component and an MFR of 97 g/10 min (measured at 190° C. with a weight of 2.16 kg and melt density of 1.05 g/cm³ according to standard ISO 1133-1), further dried at 90° C. for 2 hours, and fed to a Haake counter-rotating twin-screw extruder (barrel: 22×125 mm, 1-hole circular die with a diameter of 3 mm) forming part of a spaghetti extrusion line with water bath, dryer and cutter, operating under the following conditions
rpm: 100
flow rate: 35 rpm
thermal profile: 80-140-130-100° C.

The resulting composition consisted of 83% by weight PBAT and 17% by weight marker. 0.3 PHR of the resulting composition has then been physically mixed with the biodegradable and compostable polymer composition used in Comparative Example 5.

The mixture of granules has been converted through an injection moulding process obtaining sheets with dimensions 70×80×1 mm under the following conditions
injection temperature: 220° C.
injection pressure: 750 bar

The marker is present in an amount of 0.051% by weight in the polymer composition. The sheets obtained have been subjected to detection of the photoactive element using a spectrofluorometer, as described below. The spectra reported in FIG. 3 are an average on several spectra for each sample of Comparative Example 5 and Example 6. Mean values at emission (580 nm) are respectively 51969 cps/μA (Comparative Example 5) and 81050 cps/μA (Example 6).

Experimental: the excitation wavelength was set at 500 nm, i.e. lower than the maximum value of the excitation peak to avoid overlapping between the excitation and emission signals. The aperture of the front input and output slits were calibrated to boost the signal in order to obtain a clearly detectable signal within the linearity range of the PMT detector. The 5 nm bandwidth was kept at the same value for both Comparative Example 5 and Example 6 in order to have comparable scales. Dark offset was enabled. The corrected signal S1C on the PMT and the corrected reference signal R1C of the lamp were included in the acquisition panel to obtain S1C/R1C taking into account corrections for PMT sensitivity and intensity variations of the Xe-lamp source respectively. A 1 s accumulation time was set to obtain an averaged signal.

1. A biodegradable and compostable polymer composition comprising
at least one diacid-diol polyester (i),
optionally one or more polyhydroxyalkanoates (ii),
optionally one or more fillers (iii), and
at least one marker comprising Rhodamine B incorporated in a zeolite with a pore size of 4 Å to 12 Å (iv).

2. The biodegradable and compostable polymer composition according to claim 1, in which each of the components (i) to (iii), or a mixture thereof, is characterised by a transmittance of more than 50%, in the range from 900 nm to 1650 nm.

3. The biodegradable and compostable polymer composition according to claim 1, in which said diacid-diol polyester (i) is an aliphatic polyester.

4. The biodegradable and compostable polymer composition according to claim 3, in which said aliphatic polyester is present in an amount of from 5% to 80% by weight with respect to the total weight of the composition.

5. The biodegradable and compostable polymer composition according to claim 1, in which said diacid-diol polyester is an aliphatic-aromatic polyester.

6. The biodegradable and compostable polymer composition according to claim 5, in which said aliphatic-aromatic polyester is present in an amount from 5% to 99.9% by weight with respect to the total weight of the composition.

7. The biodegradable and compostable polymer composition according to claim 1 comprising a polyhydroxyalkanoate (ii) in an amount of from 1% to 80% by weight with respect to the total weight of the composition.

8. The biodegradable and compostable polymer composition according to claim 1, in which said polyhydroxyalkanoate (ii) is a lactic acid polyester.

9. The biodegradable and compostable polymer composition according to claim 1, in which said polyhydroxyalkanoate (ii) is a lactic acid polyester, in which said filler (iii) has an average particle diameter greater than 700 nm.

10. The biodegradable and compostable polymer composition according to claim 1, in which said filler (iii) is talc.

11. The biodegradable and compostable polymer composition according to claim 1 wherein the marker (iv) is present in amounts equal to or greater than 0.01% by weight by weight with respect to the total weight of the composition.

12. The biodegradable and compostable polymer composition according to claim 1, further comprising starch.

13. A compostable article comprising the polymer composition according to claim 1.

14. A process for preparing a biodegradable and compostable polymer composition according to claim 1 comprising the steps of
a) drying a marker comprising Rhodamine B incorporated into a zeolite having a pore size of 4 Å to 12 Å (iv), until a water content of less than 2000 ppm is obtained;
b) incorporating said marker (dispersed phase) into one or more of the components (i)-(iii) of the biodegradable polymer composition (dispersant phase) by extrusion preferably at a peak temperature of 120° C. to 220° C.

15. The process according to claim 14 in which in step b) said marker is dispersed in an amount from 10% to 60% by weight relative to the dispersant phase, said process comprising a further step c) in which the composition obtained in step b) is used as a masterbatch in a further polymer composition, at a concentration of from 0.1% to 5% by weight relative to the weight of the final composition.

16. A method for tracking biodegradable and compostable polymer compositions comprising the steps of preparing an article according to claim 13 and subjecting said article to detection of the photoactive element using a spectrofluorometer.

17. A waste sorting process which comprises using the biodegradable and compostable polymer composition according to claim 1 for tracking articles it in the waste sorting process.

18. The biodegradable and compostable polymer composition according to claim 2, in which said diacid-diol polyester (i) is an aliphatic polyester.

19. The biodegradable and compostable polymer composition according to claim 2, in which said diacid-diol polyester is an aliphatic-aromatic polyester.

20. The biodegradable and compostable polymer composition according to claim 2 comprising a polyhydroxyalkanoate (ii) in an amount of from 1% to 80% by weight with respect to the total weight of the composition.
